(19) United States
(12) Patent Application Publication
(10) Pub. No.: US 2006/0019196 A1
(43) Pub. Date: Jan. 26, 2006

(54) Planographic printing plate material, planographic printing plate, and printing process employing the same

(75) Inventor: Masaki Miyoshi, Tokyo (JP)

Correspondence Address: LUCAS & MERCANTI, LLP, 475 PARK AVENUE SOUTH, 15TH FLOOR, NEW YORK, NY, 10016, US

(73) Assignee: Konica Minolta Medical & Graphic, Inc.

(21) Appl. No.: 11/174,174

(22) Filed: Jul. 1, 2005

(30) Foreign Application Priority Data
Jul. 21, 2004 (JP) JP2004-212799

(51) Int. Cl. G03C 1/494

(52) U.S. Cl. 430/270.1

(57) ABSTRACT

Disclosed is a planographic printing plate material comprising a plastic support and provided thereon, a subbing layer containing a water-soluble resin, a hydrophilic layer containing metal oxide particles with an average particle diameter of from 3 to 100 nm, and an image formation layer containing heat melting particles or heat fusible particles in that order, the planographic printing plate material being in the form of roll, wherein a dry coating amount of the water-soluble resin in the subbing layer is in the range of from 0.001 g/m² to 3.0 g/m².

This application is based on Japanese Patent Application No. 2004-212799 filed on Jul. 21, 2004 in Japanese Patent Office, the entire content of which is hereby incorporated by reference.

### FIELD OF THE INVENTION

The present invention relates to a planographic printing plate material, a planographic printing plate, and a printing process employing the same.

### BACKGROUND OF THE INVENTION

An inexpensive planographic printing plate material for CTP (Computer to Plate) system, which can be easily handled and has a printing ability comparable with that of PS plates, is required accompanied with the digitization of printing data. Recently, a so-called processless plate material requiring no development due to a specific developer is strongly desired, which can be applied to a printing press (DI printing press) installed with a direct imaging (DI) system.

A processless plate material is considered which employs a grained aluminum plate like that of PS plates. However, in view of freedom of layer constitution and cost reduction, various processless plate materials, which employ a coated hydrophilic layer, have been proposed. At present, such a processless plate material is applied only to a DI printing press (see for example, Japanese Patent Publication No. 2938397). There are no proposals of a processless plate material having sufficient printing properties as a versatile printing plate material.

As the processless plate, a so-called thermal type printing plate material has been mainly used, on which an image is recorded employing infrared laser exposure. The thermal type printing plate material can be divided into two types. One is an ablation type printing plate material comprising a support and provided thereon, two layers being different from each other in affinity to a dampening solution or printing ink used during printing, in which the layer on the outer side is ablated by laser exposure to remove. However, in order to employ a printing plate material of this type, it is necessary that a means for removing completely scattered matter produced by ablation of the surface layer be installed in an exposure device used, which results in problem of greatly increasing cost of the device. Further, since exposure energy necessary to expose is relatively high, it is necessary to lower the scanning speed of exposure beam during exposure (for example, to decrease rate of rotation of an exposure drum), which may lower image formation speed.

The other is an on-press development type printing plate material comprising a support and provided thereon, two layers being different from each other in affinity to a dampening solution or printing ink used during printing, in which adhesion force between the two layers is varied by laser exposure and the layer at portions where the adhesion force has been reduced by laser exposure is removed on a press. Removal of the layer where the adhesion force has been reduced can be carried out according to various methods. There are, for example, a method in which that layer is brought into contact with a dampening roller to be dissolved or swelled in dampening solution, a method in which that layer is brought into contact with an ink roller to be removed employing tackiness of the ink, and a method in which that layer is brought into contact with a blanket cylinder to be removed.

As one example of this type, a planographic printing plate material and a printing process employing it are proposed (see for example, Japanese Patent O.P.I. Publication No. 2001-138652), which require no development processing, produce no ablation, and provide high sensitivity, an image with high resolution, an excellent anti-scratch property, and high printing durability.

A printing plate material in the form of roll employing a plastic support is preferred as product form, in view of printing plate material cost. In the printing plate material employing a plastic support, a hydrophilic layer is preferably formed employing a coating method, in view of printing plate performance, and the coating is carried out employing an aqueous coating solution in view of printability. Since it is difficult to coat an aqueous hydrophilic layer coating solution directly on the plastic support, a hydrophilic layer is coated on a subbing layer, which has been in advance coated on the plastic support.

Since kinds or amount of components added to the hydrophilic layer are limited in view of providing an anti-stain property, it is difficult to freely control the surface tension or viscosity of a hydrophilic layer coating solution. Therefore, it is necessary to improve wettability of a subbing layer on which the hydrophilic layer is provided, and further to increase adhesion of the subbing layer to a hydrophilic layer containing much of hydrophilic materials.

### SUMMARY OF THE INVENTION

An object of the invention is to provide a planographic printing plate material, which is subjected to simple water development or is mounted on a plate cylinder of a printing press without any prior development processing to be able to obtain a planographic printing plate, to provide a planographic printing plate with high printing durability, and to provide a printing process employing the planographic printing plate.

### DETAILED DESCRIPTION OF THE INVENTION

The above object has been attained by one of the following constitutions:
1. A planographic printing plate material comprising a plastic support and provided thereon, a subbing layer containing a water-soluble resin, a hydrophilic layer containing metal oxide particles with an average particle diameter of from 3 to 100 nm, and an image formation layer containing heat melting particles or heat fusible particles in that order, the planographic printing plate material being in the form of roll, wherein a dry coating amount of the water-soluble resin in the subbing layer is in the range of from 0.001 g/m² to 3.0 g/m².
2. The planographic printing plate material of item 1 above, wherein the water-soluble resin is selected from the group consisting of gelatin, carboxymethylcellulose, polyvinyl pyrrolidone, polyacrylic acid or its salts, and polyvinyl alcohol.
3. The planographic printing plate material of item 2 above, wherein the water-soluble resin is gelatin or polyvinyl alcohol.
4. The planographic printing plate material of item 3 above, wherein the water-soluble resin is polyvinyl alcohol.
5. The planographic printing plate material of item 1 above, wherein the subbing layer further contains an acryl resin or an acryl-modified hydrophilic polyester.
6. The planographic printing plate material of item 1 above, wherein the subbing layer consists of a first subbing layer and a second subbing layer provided on the first subbing layer, the water-soluble resin being contained in the second subbing layer.
7. The planographic printing plate material of item 1 above, wherein the metal oxide particles are colloidal silica with an average particle diameter of from 3 to 20 nm.
8. The planographic printing plate material of item 1 above, wherein the metal oxide particle content of the hydrophilic layer is from 1 to 10% by weight.
9. The planographic printing plate material of item 1 above, wherein the hydrophilic layer consists of a first hydrophilic layer and a second hydrophilic layer.
10. The planographic printing plate material of item 1 above, wherein at least one of the hydrophilic layer and the image formation layer further contains a light-to-heat conversion material.
11. The planographic printing plate material of item 1 above, wherein the image formation layer further contains a light-to-heat conversion material in an amount of 1 to 90% by weight.
12. The planographic printing plate material of item 1 above, wherein a back coat layer is provided on a rear surface of the support opposite the image formation layer.
13. The planographic printing plate material of item 12 above, wherein the back coat layer contains a matting agent having an average particle diameter of from 1 to 12 μm in an amount of from 1 to 10% by weight.
14. The planographic printing plate material of item 13 above, wherein the matting agent is an organic resin particle.
15. The planographic printing plate material of item 1 above, wherein the plastic support is a sheet of polyethylene terephthalate or polyethylene naphthalate.
16. The planographic printing plate material of item 1 above, wherein the plastic support has a thickness of from 50 to 500 μm, and a thickness dispersion of not more than 10%.
17. The planographic printing plate material of item 1 above, wherein the plastic support has a thickness of from 120 to 400 μm, and a thickness dispersion of not more than 8%.
18. A planographic printing plate, which is obtained by a process comprising the step of forming an image on the planographic printing plate material of item 1 above, employing a thermal head.
19. A printing process comprising the steps of imagewise exposing the printing plate material of item 1 above, based on image information, employing a laser, mounting the exposed printing plate material on a plate cylinder of a printing press without carrying out any wet development, and carrying out printing to print an image on a printing paper sheet.

Next, the present invention will be explained in detail.

Materials for the plastic support in the invention (hereinafter also referred to as the support in the invention) is preferably a plastic film sheet. Examples thereof include polyethylene terephthalate (PET), polyethylene naphthalate (PEN), polybutylene naphthalate (PBN), polyimide, pqlyamide, polycarbonate (PC), syndiotactic polystyrene (SPS), polysulfone, polyphenylene oxide, and cellulose ester.

The plastic support in the invention has a coefficient of elasticity at 120° C. (E120) of preferably from 9.81×10² to 58.8×10² MPa, and more preferably from 11.8×10² to 49.0×10² MPa, in view of a handling property. Examples of such a support include a sheet of PEN (E120=40.2×10² MPaPET (E120=14.7×10² MPa), PBN (E120=15.7×10² MPa), PC (E120=16.7×10² MPa), SPS (E120=21.6×10² MPa), polyetherimide (E120=18.6×10² MPa), polyarylate (E120=16.7×10² MPa), polysulfone (E120=17.7×10² MPa), and polyethersulfone (E120=16.7×10² MPa). These plastics may be used singly or as a mixture of two or more thereof. Two or more of these sheets may be laminated. Especially preferred plastic sheet is a PEN sheet or a PET sheet.

The coefficient of elasticity herein referred to is a slope of the straight line portion in the stress-strain diagram showing the relationship between strain and stress, which is obtained employing a tension test meter according to JIS C2318. This slope is called Young's modulus, which is defined in the invention as coefficient of elasticity.

It is preferred that the plastic support in the invention has an average thickness of from 50 to 500 μm, and a thickness distribution of not more than 10%, in that a handling property is improved when the planographic printing plate material is mounted on a press. The average thickness of the support in the invention is preferably from 110 to 500 μm, more preferably from 120 to 400 μm, and still more preferably from 125 to 300 μm. The thickness dispersion of the support in the invention is preferably not more than 10%, more preferably not more than 8%, and still more preferably not more than 6%. The thickness dispersion herein referred to means a value (%) obtained by dividing the difference between the maximum thickness and the minimum thickness by the average thickness and then multiplying the difference by 100. The thickness dispersion of the support is determined according to the following: lines are formed at an interval of 10 cm in both the transverse and longitudinal directions on a 60 cm square polyester film sheet to form 36 small squares. The thickness of the 36 small squares is measured, and the average thickness, maximum thickness and minimum thickness are obtained therefrom.

(Preparation Method of Support)

In order to obtain an average thickness or thickness dispersion of the support in the invention falling within the range described above, there is a method in which support forming conditions are optimized or the support prepared is treated with a smoothing roller while post heating, however, it is preferred that the support is prepared according to the following procedures.

The support in the invention is prepared by a method comprising the steps of melting a thermoplastic resin at a temperature of from the melting point (Tm) to Tm+50° C., filtering the melted resin through a filter, extruding the filtrate from a T-die, and casting it on a casting drum at a glass transition point (Tg)−50° C. to Tg to form an unstretched sheet. As a method to obtain the support with the thickness variation falling within the above-described range, a static electricity application method is preferably used.

The unstretched sheet is stretched at from Tg to Tg+50° C. by a stretching magnification of from 2 to 4. As another method to obtain the support with the thickness variation falling within the above-described range, a multi-stretching method is preferably used, in which temperature at a later stretching step is higher than that at a preceding stretching step by preferably 1 to 30° C., and more preferably 2 to 15° C.

The stretching magnification at the preceding stretching step is preferably 0.25 to 0.75 times, and more preferably 0.3 to 0.5 times the stretching magnification at the later stretching step. Thereafter, it is preferred that the stretched sheet is maintained at Tg−30° C. to Tg for 5 to 60 seconds, preferably 10 to 40 seconds, and stretched in the lateral direction at Tg to Tg+50° C. by a stretching magnification of 2.5 to 5. The resulting sheet, while held through a chuck at (Tm−50° C.) to (Tm−5° C.), is heat fixed for 5 to 120 seconds, where the interval of the chucks in the lateral direction is preferably reduced by more than 0 to 10% (heat relaxation). The heat fixed sheet is cooled, subjected to knurling treatment to give a knurl of 10 to 100 μm at the sheet edge, and wounded around a spool. Thus, a multi-axially stretched film sheet is preferably obtained.

(Particles)

Particles having a size of from 0.01 to 10 μm are preferably incorporated in an amount of from 1 to 1000 ppm into the support, in improving handling property.

Herein, the particles may be organic or inorganic material. Examples of the inorganic material include silica described in Swiss Patent 330158, glass powder described in French Patent 296995, and carbonate salts of alkaline earth metals, cadmium or zinc described in British Patent 1173181. Examples of the organic material include starch described in U.S. Pat. No. 2,322,037, starch derivatives described such as in Belgian Patent 625451 and British Patent 981198, polyvinyl alcohol described in JP-B 44-3643, polystyrene or polymethacrylate described in Swiss Patent 330158, polyacrylonitrile described in U.S. Pat. No. 3,079,257 and polycarbonate described in U.S. Pat. No. 3,022,169. The shape of the particles may be in a regular form or irregular form.

The water content of the support is preferably from 0.01 to 0.5% by weight, and more preferably from 0.01 to 0.3% by weight.

As a method of obtaining a support having a water content of not more than 0.5% by weight, there are (1) a method in which the support is heat treated at not less than 100° C. immediately before an image formation layer or another layer is coated on the support; (2) a method in which an image formation layer or another layer is coated on the support under well-controlled relative humidity; and (3) a method in which the support is heat treated at not less than 100° C. immediately before an image formation layer or another layer is coated on the support, covered with a moisture shielding sheet, and then uncovered. Two or more of these methods may be used in combination.

(Subbing Layer)

In the invention, a subbing layer which is provided between the plastic support in the invention and the hydrophilic layer, is preferably coated on the support in order to improve coatability of the hydrophilic layer and to increase its adhesion to the hydrophilic layer.

In the invention, the subbing layer preferably contains a water-soluble resin, selected from water-soluble natural and synthetic polymers. The water-soluble resin herein refers to a resin having a water solubility of 0.1 g or more in which 0.1 g or more of the resin are dissolved in 100 g of 25° C. water. Examples of the water-soluble resin include natural polymers such as gelatin, gum arabic, water-soluble soybean, polysaccharides, cellulose derivatives (for example, carboxymethylcellulose, carboxyethylcellulose, or methylcellulose) or their modification compounds, white dextrin, pullulan, curdlan chitosan, alginic acid, or enzyme-decomposed etherified dextrin; and synthetic polymers such as polyvinyl alcohol (preferably one with a saponification degree of not less than 70 mol %), polyvinyl pyrrolidone, polyacrylic acid or its alkali metal or amine salt, an acrylic acid copolymer or its alkali metal or amine salt, polyacrylic acid or its alkali metal or amine salt, vinyl alcohol-acrylic acid copolymer or its alkali metal or amine salt, a homopolymer or copolymer of acryl amide, poly(hydroxyethyl acrylate), poly(vinyl methyl ether), vinyl methyl ether-maleic anhydride copolymer, or poly(2-acrylamide-2-methyl-1-propane sulfonic acid) or its alkali metal or amine salt. However, the present invention is not limited thereto. Among these, the water-soluble resin is preferably gelatin, carboxymethylcellulose, polyvinyl alcohol, polyvinyl pyrrolidone or polyacrylic acid or its alkali metal or amine salt, more preferably gelatin and polyvinyl alcohol, and most preferably polyvinyl alcohol.

These resins can be used as an admixture of two or more kinds thereof, depending on the objective.

In the invention, it is necessary that the dry coating amount of the water-soluble resin be from 0.001 to 3.0 g/m². The dry coating amount of the water-soluble resin is preferably from 0.005 to 2.0 g/m², and more preferably from 0.01 to 1.5 g/m². When the dry coating amount of the water-soluble resin falls outside the range described above, adhesion of the subbing layer to the hydrophilic layer is insufficient, resulting in lowering of printing durability of planographic printing plate.

In the invention, it is preferred that the subbing layer further contains an acryl resin or an acryl resin-modified hydrophilic polyester. Examples of the acryl resin include a polymer obtained by polymerization of an acrylic monomer: for example, an alkyl acrylate or alkyl methacrylate (examples of the alkyl include methyl, ethyl, n-propyl, isopropyl, n-butyl, isobutyl, t-butyl, 2-ethylhexyl, cyclohexyl, phenyl, benzyl or phenethyl); a hydroxyl group-containing monomer such as 2-hydroxyethyl acrylate, 2-hydroxyethyl methacrylate, 2-hydroxypropyl acrylate, or 2-hydroxypropyl methacrylate; an amido group-containing monomer such as acryl amide, methacryl amide, N-methylmethacryl amide, N-methylacryl amide, N-methylolacryl amide, N-methylolmethacryl amide, N,N-dimethylolacryl amide, N-methoxymethylacryl amide, N-methoxymethylmethacryl amide, or N-phenylacryl amide; an amino group-containing monomer such as N,N-diethylaminoethyl acrylate or N,N-diethylaminoethyl methacrylate; an epoxy group-containing monomer such as glycidyl acrylate or glycidyl methacrylate; or a carboxyl or its salt group-containing monomer such as acrylic or methacrylic acid or their salt (sodium, potassium or ammonium salt); and a copolymer obtained by copolymerization of the acrylic monomer described above with a monomer other than the acrylic monomer (for example, an epoxy group-containing monomer such as allyl glycidyl ether; a sulfo or its salt group-containing monomer such as styrene sulfonic acid, vinyl sulfonic acid or their salt (sodium, potassium or ammonium salt), a carboxyl or its salt group-containing monomer such as crotonic acid, itaconic acid, maleic acid, fumaric acid or their salt (sodium, potassium or ammonium salt); an anhydride monomer such as maleic anhydride or itaconic anhydride; vinyl isocyanate; allyl isocyanate; styrene; vinyltrisalkoxysilane; alkylmaleic acid monoester; alkylfumaric acid monoester; acrylonitrile; methacrylonitrile; alkylitaconic acid monoester; vinylidene chloride; vinyl acetate; or vinyl chloride). As the monomers used, an epoxy group-containing monomer such as glycidyl acrylate or glycidyl methacrylate is preferred.

Examples of the polymerization initiator used in the polymerization or copolymerization above include ammonium persulfate, potassium persulfate, sodium persulfate, and benzoyl peroxide. Among these, ammonium persulfate is preferred. Polymerization can be carried out without employing a surfactant, but it is possible to carry out polymerization employing a surfactant in order to secure polymerization stability. As the surfactant, a nonionic or anionic surfactant can be employed.

The acryl-modified hydrophilic polyester is one obtained by polymerizing an acryl monomer dispersed in an aqueous solution containing a hydrophilic polyester. The acryl-modified hydrophilic polyester can be obtained for example by dissolving the hydrophilic polyester in hot water to obtain an aqueous hydrophilic polyester solution, dispersing an acrylic monomer in the resulting solution, and dispersion or emulsion polymerizing the acryl monomer. In the invention, emulsion polymerization is preferably carried out. Herein, the hydrophilic polyester means a (co)polyester comprising in the molecule a sulfo group or its alkali metal salt or a carboxyl group or its alkali metal salt.

The acryl resin in the invention is preferably in the form of polymer latex. Herein, the polymer latex is a water-insoluble polymer, which is dispersed in water or an aqueous dispersion medium in the form of particles. The polymer latex may be one in which a polymer is emulsified in a dispersion medium, one obtained by emulsion polymerization, one in which a polymer is dispersed in the form of micelles or one in which a polymer partially having a hydrophilic structure is molecularly dispersed. Polymer latexes are described in “Synthetic Resin Emulsion” (edited by T. Okuda and H. Inagaki, published by KOBUNSHI-KANKOKAI, 1978), “Application of Synthetic Latex” (edited by Sugimura et al., published by KOBUNSHI-KANKOKAI, 1993), and “Chemistry of Synthetic Latex” (S. Muroi, published by KOBUNSHI-KANKOKAI, 1970).

The polymer latex has an average particle size of preferably from 1 to 50000 nm, and more preferably from 5 to 1000 nm. The particle size distribution of the latex may be polydisperse or monodisperse.

The polymer latex of acryl resin type in the invention may be a polymer latex having a uniform structure or a core-shell type polymer latex. In the core-shell type polymer latex, one may be preferred in which a polymer constituting the core is different in glass transition temperature from a polymer constituting the shell.

The minimum film forming temperature: (MFT) of the polymer latex of acryl resin type in the invention is preferably from −30 to 90° C., and more preferably from 0 to 70° C. In the invention, a film forming aid may be added to control the minimum film forming temperature. Such a film forming aid is called a plasticizer, and is an organic compound (usually an organic solvent), which lowers the minimum film forming temperature of the polymer latex. Such an organic compound is described, for example, in S. Muroi, “Gousei Latex no Kagaku (Chemistry of Synthesized Latex)”, published by Koubunshi Kankoukai (1970).

In the invention, a subbing layer consisting of two layers, i.e., an outer subbing layer and a lower subbing layer under the outer subbing layer, is also efficient, and in this case, the outer subbing layer contains the water-soluble resin.

An electrically conductive layer, for example, an electrically conductive polymer-containing layer disclosed in items [0031] through [0073] of Japanese Patent O.P.I. Publication No. 7-20596 or a metal oxide-containing layer disclosed in items [0074] through [0081] of Japanese Patent O.P.I. Publication No. 7-20596 is preferably provided. The electrically conductive layer may be provided on any surface side of the support, but is provided preferably on the surface of the support opposite the image formation layer. The electrically conductive layer improves electrification property, reduces dust adhesion, and greatly lowers printing failure such as white spot occurrence during printing.

The support in the invention is preferably a plastic sheet, but may be a composite support in which a plate of a metal (for example, iron, stainless steel or aluminum) or a polyethylene-laminated paper sheet is laminated onto the plastic sheet. The composite support may be one in which the lamination is carried out before any layer is coated on the support, one in which the lamination is carried out after any layer has been coated on the support, or one in which the lamination is carried out immediately before mounted on a printing press.

In the invention, the above-described subbing layer can be subjected to adhesion increasing treatment. Examples of the adhesion increasing treatment include corona discharge treatment, flame treatment, plasma treatment and UV light irradiation treatment.

(Stiffness)

The plastic support used in planographic printing plate material of the invention has a stiffness of preferably 50 to 500 g. Stiffness less than 50 g provides low stiffness of planographic printing plate material, while stiffness exceeding 500 g provides too high stiffness of planographic printing plate material, the both making it difficult to handle the planographic printing plate material or to mount the planographic printing plate material on a plate cylinder of a printing press.

Stiffness can be measured, employing a stiffness tester available on the market, for example, “a stiffness tester UT-100-230” or “a stiffness tester UT-200GR” each produced by Toyo Seiki Seisakusho Co., Ltd.

Stiffness is measured as follows:

A sample of a size of 20 cm×10 cm is placed on the two horizontal plates, so that 5 cm of the longer side of each edge of the sample is fixed on each of the plates. Subsequently, the two plates are moved to approach each other so that the sample is pushed upward at the center to form a convex shape, the top of which is 1 cm higher than the edges of the sample, and then, a load necessary to push down the resulting top of the convex-shaped sample by 3 mm is measured and defined as the stiffness.

(Hydrophilic Layer)

Materials used in the hydrophilic layer of the planographic printing plate material will be explained below.

Material used in the hydrophilic layer is preferably a metal oxide, and more preferably metal oxide particles. Examples of the metal oxide particles include colloidal silica particles, an alumina sol, a titania sol and another metal oxide sol. The metal oxide particles may have any shape such as spherical, needle-like, and feather-like shape. The average particle diameter is preferably from 3 to 100 nm, and plural kinds of metal oxide each having a different size may be used in combination. The surface of the particles may be subjected to surface treatment.

The metal oxide particles can be used as a binder, utilizing its layer forming ability. The metal oxide particles are suitably used in a hydrophilic layer since they minimize lowering of the hydrophilicity of the layer as compared with an organic compound binder. Among the above-mentioned, colloidal silica is particularly preferred. The colloidal silica has a high layer forming ability under a drying condition with a relative low temperature, and can provide a good layer strength. It is preferred that the colloidal silica used in the invention is necklace-shaped colloidal silica or colloidal silica having an average particle diameter of not more than 20 nm, and preferably from 3 to 20 nm, each being described later. Further, it is preferred that the colloidal silica provides an alkaline colloidal silica solution as a colloid solution.

The necklace-shaped colloidal silica to be used in the invention is a generic term of an aqueous dispersion system of spherical silica having a primary particle diameter of the order of nm. The necklace-shaped colloidal silica to be used in the invention means a “pearl necklace-shaped” colloidal silica formed by connecting spherical colloidal silica particles each having a primary particle diameter of from 10 to 50 μm so as to attain a length of from 50 to 400 nm. The term of “pearl necklace-shaped” means that the image of connected colloidal silica particles is like to the shape of a pearl necklace.

The bonding between the silica particles forming the necklace-shaped colloidal silica is considered to be —Si—O—Si—, which is formed by dehydration of —SiOH groups located on the surface of the silica particles. Concrete examples of the necklace-shaped colloidal silica include Snowtex-PS series produced by Nissan Kagaku Kogyo, Co., Ltd.

As the products, there are Snowtex-PS—S (the average particle diameter in the connected state is approximately 110 nm), Snowtex-PS-M (the average particle diameter in the connected state is approximately 120 nm) and Snowtex-PS-L (the average particle diameter in the connected state is approximately 170 nm). Acidic colloidal silicas corresponding to each of the above-mentioned are Snowtex-PS-S-O, Snowtex-PS-M-O and Snowtex-PS-L-O, respectively.

The necklace-shaped colloidal silica is preferably used in a hydrophilic layer as a porosity providing material for hydrophilic matrix phase, and porosity and strength of the layer can be secured by its addition to the layer. Among them, the use of Snowtex-PS-S, Snowtex-PS-M or Snowtex-PS-L, each being alkaline colloidal silica particles, is particularly preferable since the strength of the hydrophilic layer is increased and occurrence of background contamination is inhibited even when a lot of prints are printed.

It is known that the binding force of the colloidal silica particles is become larger with decrease of the particle diameter. The average particle diameter of the colloidal silica particles to be used in the invention is preferably not more than 20 nm, and more preferably 3 to 15 nm. As above-mentioned, the alkaline colloidal silica particles show the effect of inhibiting occurrence of the background contamination. Accordingly, the use of the alkaline colloidal silica particles is particularly preferable. Examples of the alkaline colloidal silica particles having the average particle diameter within the foregoing range include Snowtex-20 (average particle diameter: 10 to 20 nm), Snowtex-30 (average particle diameter: 10 to 20 nm), Snowtex-40 (average particle diameter: 10 to 20 nm), Snowtex-N (average particle diameter: 10 to 20 nm), Snowtex-S (average particle diameter: 8 to 11 nm) and Snowtex-XS (average particle diameter: 4 to 6 nm), each produced by Nissan Kagaku Co., Ltd.

The colloidal silica particles having an average particle diameter of not more than 20 nm, when used together with the necklace-shaped colloidal silica as described above, is particularly preferred, since appropriate porosity of the layer is maintained and the layer strength is further increased. The ratio of the colloidal silica particles having an average particle diameter of not more than 20 nm to the necklace-shaped colloidal silica is preferably from 95/5 to 5/95, more preferably from 70/30 to 20/80, and most preferably from 60/40 to 30/70.

The hydrophilic layer of the printing plate material in the invention can contain porous metal oxide particles with a particle diameter of less than 1 μm as porosity providing material. Examples of the porous metal oxide particles include porous silica particles, porous aluminosilicate particles or zeolite particles as described later.

The porous silica particles are ordinarily produced by a wet method or a dry method. By the wet method, the porous silica particles can be obtained by drying and pulverizing a gel prepared by neutralizing an aqueous silicate solution, or pulverizing the precipitate formed by neutralization. By the dry method, the porous silica particles are prepared by combustion of silicon tetrachloride together with hydrogen and oxygen to precipitate silica.

The porosity and the particle diameter of such particles can be controlled by variation of the production conditions. The porous silica particles prepared from the gel by the wet method is particularly preferred. The porous aluminosilicate particles can be prepared by the method described in, for example, JP O.P.I. No. 10-71764. Thus prepared aluminosilicate particles are amorphous complex particles synthesized by hydrolysis of aluminum alkoxide and silicon alkoxide as the major components. The particles can be synthesized so that the ratio of alumina to silica in the particles is within the range of from 1:4 to 4:1. Complex particles composed of three or more components prepared by an addition of another metal alkoxide may also be used in the invention. In such a particle, the porosity and the particle diameter can be controlled by adjustment of the production conditions.

The porosity of the particles is preferably not less than 1.0 ml/g, more preferably not less than 1.2 ml/g, and most preferably of from 1.8 to 2.5 ml/g, in terms of pore volume before the dispersion. The pore volume is closely related to water retention of the coated layer. As the pore volume increases, the water retention is increased, stain is difficult to occur, and water tolerance is high. Particles having a pore volume of more than 2.5 ml/g are brittle, resulting in lowering of durability of the layer containing them. Particles having a pore volume of less than 1.0 ml/g may provide insufficient printing property.

The metal oxide particle content of the hydrophilic layer is preferably from 0.1 to 30% by weight, and more preferably from 1 to 10% by weight.

As porosity providing material, zeolite can be used.

Zeolite is a crystalline aluminosilicate, which is a porous material having voids of a regular three dimensional net work structure and having a pore size of 0.3 to 1 nm. Natural and synthetic zeolites are expressed by the following formula.
(M¹, (M²)_{1/2})ₘ(AlₘSiₙO₂₍ₘ₊ₙ₎).xH₂O

In the above, M and M are each exchangeable cations. Examples of M¹ include Li⁺, Na⁺, K⁺, Tl⁺, Me₄N⁺ (TMA), Et₄N⁺ (TEA), Pr₄N⁺ (TPA), C₇H₁₅N²⁺, and C₈H₁₆N⁺, and examples of M² include Ca²⁺, Mg²⁺, Ba²⁺, Sr²⁺ and (C₈H₁₈N)₂²⁺. “Me” represents a methyl group, “Et” an ethyl group, and “Process” a propyl group.

Relation of n and m is n≧m, and consequently, the ratio of m/n, or that of Al/Si is not more than 1. A higher Al/Si ratio shows a higher content of the exchangeable cation, and a higher polarity, resulting in higher hydrophilicity. The Al/Si ratio is within the range of preferably from 0.4 to 1.0, and more preferably 0.8 to 1.0. x is an integer.

Synthetic zeolite having a stable Al/Si ratio and a sharp particle diameter distribution is preferably used as the zeolite particles to be used in the invention. Examples of such zeolite include Zeolite A: Na₁₂(Al₁₂Si₁₂O₄₈).27H₂O; Al/Si=1.0, Zeolite X: Na₈₆(Al₈₆Si₁₀₆O₃₈₄).264H₂O; Al/Si=0.811, and Zeolite Y: Na₅₆(Al₅₆Si₁₃₆O₃₈₄).250H₂O; Al/Si=0.412. Containing the porous zeolite particles having an Al/Si ratio within the range of from 0.4 to 1.0 in the hydrophilic layer greatly raises the hydrophilicity of the hydrophilic layer itself, whereby contamination in the course of printing is inhibited and the water retention latitude is also increased. Further, contamination caused by a finger mark is also greatly reduced. When Al/Si is less than 0.4, the hydrophilicity is insufficient and the above-mentioned improving effects are lowered.

The hydrophilic layer of the printing plate material in the invention can contain layer structural clay mineral particles as a metal oxide. Examples of the layer structural clay mineral particles include a clay mineral such as kaolinite, halloysite, talk, smectite such as montmorillonite, beidellite, hectorite and saponite, vermiculite, mica and chlorite; hydrotalcite; and a layer structural polysilicate such as kanemite, makatite, ilerite, magadiite and kenyte. Among them, ones having a higher electric charge density of the unit layer are higher in the polarity and in the hydrophilicity. Preferable charge density is not less than 0.25, more preferably not less than 0.6. Examples of the layer structural mineral particles having such a charge density include smectite having a negative charge density of from 0.25 to 0.6 and bermiculite having a negative charge density of from 0.6 to 0.9. Synthesized fluorinated mica is preferable since one having a stable quality, such as the particle diameter, is available. Among the synthesized fluorinated mica, swellable one is preferable and one freely swellable is more preferable.

An intercalation compound of the foregoing layer structural mineral particles such as a pillared crystal, or one treated by an idn exchange treatment or a surface treatment such as a silane coupling treatment or a complication treatment with an organic binder is also usable.

The planar structural mineral particles are preferably in the plate form, and have an average particle diameter (an average of the largest particle length) of less than 1 μm, and an average aspect ratio (the largest particle length/the particle thickness) of preferably not less than 50, in a state contained in the layer including the case that the particles are subjected to a swelling process and a dispersing layer-separation process. When the particle diameter is within the foregoing range, continuity to the parallel direction, which is a trait of the layer structural particle, and softness, are given to the coated layer so that a strong dry layer in which a crack is difficult to be formed can be obtained. The coating solution containing the layer structural clay mineral particles in a large amount can minimize particle sedimentation due to a viscosity increasing effect. The particle diameter falling outside the above range may produce non-uniformity in the coated layer, resulting in lowering strength of the layer. The aspect ratio less than the lower limit of the above range reduces the number of the particles relative to the addition amount, and lowers viscosity increasing effect, resulting in lowering of particle sedimentation resistance.

The content of the layer structural clay mineral particles is preferably from 0.1 to 30% by weight, and more preferably from 1 to 10% by weight based on the total weight of the layer. Particularly, the addition of the swellable synthesized fluorinated mica or smectite is effective if the adding amount is small. The layer structural clay mineral particles may be added in the form of powder to a coating liquid, but it is preferred that gel of the particles which is obtained by being swelled in water, is added to the coating liquid in order to obtain a good dispersity according to an easy coating liquid preparation method which requires no dispersion process comprising dispersion due to media.

An aqueous solution of a silicate is also usable as another additive to the hydrophilic matrix phase in the invention. An alkali metal silicate such as sodium silicate, potassium silicate or lithium silicate is preferable, and the ratio SiO₂/M₂O is preferably selected so that the pH value of the coating liquid after addition of the silicate does not exceed 13 in order to prevent dissolution of the porous metal oxide particles or the colloidal silica particles.

An inorganic polymer or an inorganic-organic hybrid polymer prepared by a sol-gel method employing a metal alkoxide. Known methods described in S. Sakka “Application of Sol-Gel Method” or in the publications cited in the above publication can be applied to prepare the inorganic polymer or the inorganic-organic hybrid polymer by the sol-gel method.

The hydrophilic layer may contain a water soluble resin. Examples of the water soluble resin include polysaccharides, polyethylene oxide, polypropylene oxide, polyvinyl alcohol, polyethylene glycol (PEG), polyvinyl ether, a styrene-butadiene copolymer, a conjugation diene polymer latex of methyl methacrylate-butadiene copolymer, an acryl polymer latex, a vinyl polymer latex, polyacrylamide, and polyvinyl pyrrolidone. In the invention, polysaccharides are preferred. As the polysaccharide, starches, celluloses, polyuronic acid and pullulan can be used. Among them, a cellulose derivative such as a methyl cellulose salt, a carboxymethyl cellulose salt or a hydroxyethyl cellulose salt is preferable, and a sodium or ammonium salt of carboxymethyl cellulose is more preferable. These polysaccharides can form a preferred surface shape of the hydrophilic layer.

The surface of the hydrophilic layer preferably has a convexoconcave structure having a pitch of from 0.1 to 20 μm such as the grained aluminum surface of an aluminum PS plate. The water retention ability and the image maintaining ability are raised by such a convexoconcave structure of the surface. Such a convexoconcave structure can also be formed by adding in an appropriate amount a filler having a suitable particle diameter to the coating liquid of the hydrophilic layer. However, the convexoconcave structure is preferably formed by coating a coating liquid for the hydrophilic layer containing the alkaline colloidal silica and the water-soluble polysaccharide so that the phase separation occurs at the time of drying the coated liquid, whereby a structure is obtained which provides a good printing performance. The shape of the convexoconcave structure such as the pitch and the surface roughness thereof can be suitably controlled by the kinds and the adding amount of the alkaline colloidal silica particles, the kinds and the adding amount of the water-soluble polysaccharide, the kinds and the adding amount of another additive, a solid concentration of the coating liquid, a wet layer thickness or a drying condition.

It is preferred that the water soluble resin is contained in the hydrophilic layer in such a state that at least a part of the water soluble resin is capable of being dissolved in water. This is because even the water soluble resin, when cross-linked with a cross-linking agent, is water insoluble, which lowers its hydrophilicity and printing properties.

A cationic resin may also be contained in the hydrophilic layer. Examples of the cationic resin include a polyalkylene-polyamine such as a polyethyleneamine or polypropylenepolyamine or its derivative, an acryl resin having a tertiary amino group or a quaternary ammonium group and diacrylamine. The cationic resin may be added in a form of fine particles. Examples of such particles include the cationic microgel described in Japanese Patent O.P.I. Publication No. 6-161101.

A water-soluble surfactant may be added for improving the coating ability of the coating liquid for the hydrophilic layer in the invention. A silicon atom-containing surfactant and a fluorine atom-containing surfactant are preferably used. The silicon atom-containing surfactant is especially preferred in that it minimizes printing contamination. The content of the surfactant is preferably from 0.01 to 3% by weight, and more preferably from 0.03 to 1% by weight based on the total weight of the hydrophilic layer (or the solid content of the coating liquid).

The hydrophilic layer in the invention can contain a phosphate. Since a coating liquid for the hydrophilic layer is preferably alkaline, the phosphate to be added to the hydrophilic layer is preferably sodium phosphate or sodium monohydrogen phosphate. The addition of the phosphate provides improved reproduction of dots at shadow portions. The content of the phosphate is preferably from 0.1 to 5% by weight, and more preferably from 0.5 to 2% by weight in terms of amount excluding hydrated water.

The hydrophilic layer can contain a light-to-heat conversion material described later. The light-to-heat conversion material, when particles, is preferably ones with a particle diameter of less than 1 μm.

Any of a porous substance, a non-porous substance, organic resin particles or inorganic particles can be used. Examples of the inorganic fillers include silica, alumina, zirconia, titania, carbon black, graphite, TiO₂, BaSO₄, ZnS, MgCO₃, CaCO₃, ZnO, CaO, WS₂, MoS₂, MgO, SnO₂, Al₂O₃, α-Fe₂O₃, α-FeOOH, SiC, CeO₂, BN, SiN, MoC, BC, WC, titanium carbide, corundum, artificial diamond, garnet, garnet, quartz, silica rock, tripoli, diatomite, and dolomite. Examples of the organic fillers include polyethylene fine particles, fluororesin particles, guanamine resin particles, acrylic resin particles, silicone resin particles, melamine resin particles, and the like. As the inorganic material coated fillers, there are, for example, particles in which organic particles such as particles of PMMA or polystyrene as core particles are coated with inorganic particles with a particle diameter smaller that that of the core particles. The particle diameter of the inorganic particles is preferably from 1/10 to 1/100 of that of the core particles. As the inorganic particles, particles of known metal oxides such silica, alumina, titania and zirconia can be used. Various coating methods can be used, but a dry process is preferred which core particles collide with particles for coating at high speed in air as in a hybridizer to push the particles for coating in the core particle surface and fix, whereby the core particles are coated with the particles for coating.

Particles, in which the organic core particles are plated with metal, can be used. As such particles, there is, for example, “Micropearl AU”, produced by SEKISUI KAGAKU KOGYO Co, Ltd., in which resin particles are plated with gold.

Particularly in order to minimize particle sedimentation in a coating liquid, porous inorganic fillers such as porous silica particles or porous aluminosilicate particles, or fillers covered with porous inorganic particles are preferably used. The particle diameter of the fillers is preferably from 1 to 12 μm, more preferably from 1.5 to 8 μm, and still more preferably from 2 to 6 μm. The particles diameter exceeding 12 μm results in problem of lowering dissolution of formed images or contaminating a blanket. The particles described above with a particle diameter of not less than 1 μm are contained in the hydrophilic layer in an amount of preferably from 1 to 50% by weight, and more preferably from 5 to 40% by weight.

In the hydrophilic layer, the content of carbon-containing materials such as organic resins or carbon black is preferably low in increasing hydrophilicity. The content of the carbon-containing materials in the hydrophilic layer is preferably less than 9% by weight, and more preferably less than 5% by weight.

In the invention, an under layer may be provided under the hydrophilic layer, and when the under layer is provided, materials used in the under layer include the same materials as in the hydrophilic layer described above. The under layer, when it is porous, is less advantageous. Since the under layer is preferably non-porous in view of strength of the layer, the porosity providing agent content of the under layer is preferably lower than that of the hydrophilic layer. It is more preferable that the under layer contains no porosity providing agent.

The content of the particles having a particle diameter of not less than 1 μm described above in the under layer is preferably from 1 to 50% by weight, and more preferably from 5 to 40% by weight.

Like the hydrophilic layer, the content of carbon-containing materials such as the organic resins or carbon black in the under layer is preferably lower in increasing hydrophilicity of the under layer. The total content of these materials in the under layer is preferably less than 9% by weight, and more preferably less than 5% by weight.

(Image Formation Layer)

In the invention, the image formation layer containing heat melting particles and/or heat fusible particles can contain materials as described below.

The heat melting particles are particularly particles having a low melt viscosity, which are particles formed from materials generally classified into wax. The materials preferably have a softening point of from 40° C. to 120° C. and a melting point of from 60° C. to 150° C., and more preferably a softening point of from 40° C. to 100° C. and a melting point of from 60° C. to 120° C. The melting point less than 60° C. has a problem in storage stability and the melting point exceeding 300° C. lowers ink receptive sensitivity.

Materials usable include paraffin wax, polyolefin wax, polyethylene wax, microcrystalline wax, and waxes of fatty acids or their derivatives. The molecular weight thereof is approximately from 800 to 10,000. A polar group such as a hydroxyl group, an ester group, a carboxyl group, an aldehyde group and a peroxide group may be introduced into the wax by oxidation to increase the emulsification ability. Moreover, stearoamide, linolenamide, laurylamide, myristylamide, hardened cattle fatty acid amide, parmitylamide, oleylamide, rice bran oil fatty acid amide, palm oil fatty acid amide, a methylol compound of the above-mentioned amide compounds, methylenebissteastearoamide and ethylenebissteastearoamide may be added to the wax to lower the softening point or to raise the working efficiency. A cumarone-indene resin, a rosin-modified phenol resin, a terpene-modified phenol resin, a xylene resin, a ketone resin, an acryl resin, an ionomer and a copolymer of these resins may also be usable. Among them, polyethylene, microcrystalline, fatty acid esters, fatty acid amides and higher fatty acids are preferred. A high sensitive image formation can be performed since these materials each have a relative low melting point and a low melt viscosity. These materials each have a lubrication ability. Accordingly, even when a shearing force is applied to the surface layer of the printing plate precursor, the layer damage is minimized, and resistance to stain which may be caused by scratch is further enhanced.

The heat melting particles are preferably dispersible in water. The average particle size thereof is preferably from 0.01 to 10 μm, and more preferably from 0.1 to 3 μm. When a layer containing heat melting particles having an average particle size less than 0.01 μm is coated on a porous hydrophilic layer described later, the particles may enter the pores of the hydrophilic layer or the valleys between the neighboring two peaks on the hydrophilic layer surface, resulting in insufficient on-press developability, and in stain occurrence at backgrounds. On the other hand, heat melting particles having an average particle size exceeding 10 μm may result in lowering of dissolving power.

The composition of the heat melting particles may be continuously varied from the interior to the surface of the particles. The particles may be covered with a different material. Known microcapsule production method or sol-gel method can be applied for covering the particles.

The heat melting particle content of the layer is preferably 1 to 90% by weight, and more preferably 5 to 80% by weight based on the total layer weight.

The heat fusible particles in the invention include thermoplastic hydrophobic polymer particles. Although there is no specific limitation to the upper limit of the softening point of the thermoplastic hydrophobic polymer, the softening point is preferably lower than the decomposition temperature of the polymer. The weight average molecular weight (Mw) of the thermoplastic hydrophobic polymer is preferably within the range of from 10,000 to 1,000,000.

Examples of the polymer consisting the polymer particles include a diene (co)polymer such as polypropylene, polybutadiene, polyisoprene or an ethylene-butadiene copolymer; a synthetic rubber such as a styrene-butadiene copolymer, a methyl methacrylate-butadiene copolymer or an acrylonitrile-butadiene copolymer; a (meth)acrylate (co)polymer or a (meth)acrylic acid (co)polymer such as polymethyl methacrylate, a methyl methacrylate-(2-ethylhexyl)acrylate copolymer, a methyl methacrylate-methacrylic acid copolymer, or a methyl acrylate-(N-methylolacrylamide); polyacrylonitrile; a vinyl ester (co)polymer such as a polyvinyl acetate, a vinyl acetate-vinyl propionate copolymer and a vinyl acetate-ethylene copolymer, or a vinyl acetate-2-hexylethyl acrylate copolymer; and polyvinyl chloride, polyvinylidene chloride, polystyrene and a copolymer thereof. Among them, the (meth)acrylate polymer, the (meth)acrylic acid (co)polymer, the vinyl ester (co)polymer, the polystyrene and the synthetic rubbers are preferably used.

The polymer particles may be prepared from a polymer synthesized by any known method such as an emulsion polymerization method, a suspension polymerization method, a solution polymerization method and a gas phase polymerization method. The particles of the polymer synthesized by the solution polymerization method or the gas phase polymerization method can be produced by a method in which an organic solution of the polymer is sprayed into an inactive gas and dried, and a method in which the polymer is dissolved in a water-immiscible solvent, then the resulting solution is dispersed in water or an aqueous medium and the solvent is removed by distillation. In both of the methods, a surfactant such as sodium lauryl sulfate, sodium dodecylbenzenesulfate or polyethylene glycol, or a water-soluble resin such as poly(vinyl alcohol) may be optionally used as a dispersing agent or stabilizing agent.

The heat fusible particles are preferably dispersible in water. The average particle size thereof is preferably from 0.01 to 10 μm, and more preferably from 0.1 to 3 μm. When a layer containing heat fusible particles having an average particle size less than 0.01 μm is coated on a porous hydrophilic layer described later, the particles may enter the pores of the hydrophilic layer or the valleys between the neighboring two peaks on the hydrophilic layer surface, resulting in insufficient on-press developability, and in stain occurrence at backgrounds. On the other hand, heat fusible particles having an average particle size exceeding 10 μm may result in lowering of dissolving power.

Further, the composition of the heat fusible particles may be continuously varied from the interior to the surface of the particles. The particles may be covered with a different material. As a covering method, known methods such as a microcapsule method and a s01-gel method are usable. The heat fusible particle content of the image formation layer is preferably from 1 to 90% by weight, and more preferably from 5 to 80% by weight based on the total weight of the image formation layer.

In the invention, the image formation layer containing heat melting particles and/or heat fusible particles can further contain a water soluble material. When the image formation layer at unexposed portions is removed on a press with dampening water or ink, the water soluble material makes it possible to easily remove the layer.

Regarding the water soluble material, those described above as water soluble materials to be contained in the hydrophilic layer can be used. The image formation layer in the invention preferably contains saccharides, and more preferably contains oligosaccharides. Since the oligosaccharides are easily dissolved in water, removal on a press of unexposed portions of an oligosaccharide-containing layer can be easily carried out dissolving the saccharide in water. The removal does not require a specific system, and can be carried out conducting the same manner as in the beginning of printing of a conventional PS plate, which does not increase loss of prints at the beginning of printing. Use of the oligosaccharide does not lower hydrophilicity of the hydrophilic layer and can maintain good printing performance of the hydrophilic layer.

The oligosaccharide is a water-soluble crystalline substance generally having a sweet taste, which is formed by a dehydration condensation reaction of plural monosaccharide molecules. The oligosaccharide is one kind of o-glycoside having a saccharide as the aglycon. The oligosaccharide is easily hydrolyzed by an acid to form a monosaccharide, and is classified according to the number of monosaccharide molecules of the resulting hydrolysis compounds, for example, into disaccharide, trisaccharide, tetrasaccharide, and pentasscharide. The oligosaccharide referred to in the invention means di- to deca-saccharides. The oligosaccharide is classified into a reducing oligosaccharide and a non-reducing oligosaccharide according to presence or absence of a reducing group in the molecule. The oligosaccharide is also classified into a homo-oligosaccharide composed of the same kind of monosaccharide and a hetero-oligosaccharide composed of two or more kinds of monosaccharides.

The oligosaccharide naturally exists in a free state or a glycoside state. Moreover, various oligosaccharides are formed by glycosyl transition by action of an enzyme. The oligosaccharide frequently exists in a hydrated state in an ordinary atmosphere. The melting points of the hydrated one and anhydrous one are different from each other.

In the invention, the layer containing a saccharide is preferably formed coating an aqueous coating solution containing the saccharide on a support. When an oligossccharide in the layer formed from the aqueous coating solution is one capable of forming a hydrate, the melting point of the oligosaccharide is that of its hydrate. Since the oligosaccharides, having a relatively low melting point, also melt within the temperature range at which heat melting particles melt or heat fusible particles fuse, they do not cause image formation inhibition resulting from permeation of the heat melting particles into the porous hydrophilic layer and/or fusion adhesion of the heat fusible particles to the hydrophilic layer.

Among the oligosaccharides, trehalose with comparatively high purity is available on the market, and has an extremely low hygroscopicity, although it has high water solubility, providing excellent storage stability and excellent development property on a printing press. When oligosaccharide hydrates are heat melted to remove the hydrate water and solidified, the oligosaccharide is in a form of anhydride for a short period after solidification. Trehalose is characterized in that a melting point of trehalose anhydride is not less than 100° C. higher that that of trehalose hydrate. This characteristics provides a high melting point and reduced heat fusibility at exposed portions of the trehalose-containing layer immediately after heat-fused by infrared ray exposure and re-solidified, preventing image defects at exposure such as banding from occurring. In order to attain the object of the invention, trehalose is preferable among oligosaccharides.

The oligosaccharide content of the layer is preferably from 1 to 90% by weight, and more preferably from 10 to 80% by weight, based on the total weight of the layer.

In the invention, image formation on the planographic printing plate material of the invention can be carried out by applying heat, and is carried out preferably by infrared laser exposure. Exposure applied in the invention is preferably scanning exposure, which is carried out employing a laser which can emit light having a wavelength of infrared and/or near-infrared regions, that is, a wavelength of from 700 to 1500 nm. As the laser, a gas laser can be used, but a semi-conductor laser, which emits light having a near-infrared region wavelength, is preferably used.

A device suitable for the scanning exposure in the invention may be any device capable of forming an image on the printing plate precursor according to image signals from a computer employing a semi-conductor laser.

Generally, the following three exposure processes are mentioned.
(1) A process in which a plate precursor provided on a fixed horizontal plate is scanning exposed in two dimensions, employing one or several laser beams.
(2) A process in which the surface of a plate precursor provided along the inner peripheral wall of a fixed cylinder is subjected to scanning exposure in the rotational direction (in the main scanning direction) of the cylinder, employing one or several lasers located inside the cylinder, moving the lasers in the normal direction (in the sub-scanning direction) to the rotational direction of the cylinder.
(3) A process in which the surface of a plate precursor provided along the outer peripheral wall of a fixed cylinder is subjected to scanning exposure in the rotational direction (in the main scanning direction) of the cylinder, employing one or several lasers located inside the cylinder, moving the lasers in the normal direction (in the sub-scanning direction) to the rotational direction of the cylinder.

In the invention, the process (3) above is preferable, and especially preferable when a printing plate precursor mounted on a plate cylinder of a printing press is scanning exposed.

(Light-to-Heat Conversion Material)

The hydrophilic layer or image formation layer in the invention preferably contains a light-to-heat conversion material described later in order to obtain high sensitivity.

The hydrophilic layer can contain the following metal oxides as the light-to-heat conversion material.

Materials having black color in the visible regions or materials, which are electro-conductive or semi-conductive, can be used. Examples of the former include black iron oxide and black complex metal oxides containing at least two metals. Examples of the latter include Sb-doped SnO₂ (ATO), Sn-added In₂O₃ (ITO), TiO₂, TiO prepared by reducing TiO₂ (titanium oxide nitride, generally titanium black). Particles prepared by covering a core material such as BaSO₄, TiO₂, 9Al₂O₃.2B₂O and K₂OnTiO₂ with these metal oxides is usable. These oxides are particles having a particle diameter of not more than 0.5 μm, preferably not more than 100 nm, and more preferably not more than 50 nm.

As these light-to-heat conversion materials, black iron oxide or black complex metal oxides containing at least two metals are more preferred.

Examples of the black complex metal oxides include complex metal oxides comprising at least two selected from Al, Ti, Cr, Mn, Fe, Co, Ni, Cu, Zn, Sb, and Ba. These can be prepared according to the methods disclosed in Japanese Patent O.P.I. Publication Nos. 9-27393, 9-25126, 9-237570, 9-241529 and 10-231441.

The complex metal oxide used in the invention is preferably a complex Cu—Cr—Mn type metal oxide or a Cu—Fe—Mn type metal oxide. The Cu—Cr—Mn type metal oxides are preferably subjected to the treatment disclosed in Japanese Patent O.P.I. Publication Nos. 8-27393 in order to reduce isolation of a 6-valent chromium ion. These complex metal oxides have a high color density and a high light heat conversion efficiency as compared with another metal oxide.

The primary average particle diameter of these complex metal oxides is preferably from 0.001 to 1.0 μm, and more preferably from 0.01 to 0.5 μm. The primary average particle diameter of from 0.001 to 1.0 μm improves a light heat conversion efficiency relative to the addition amount of the particles, and the primary average particle diameter of from 0.05 to 0.5 μm further improves a light heat conversion efficiency relative to the addition amount of the particles. The light heat conversion efficiency relative to the addition amount of the particles depends on a dispersity of the particles, and the well-dispersed particles have a high light heat conversion efficiency. Accordingly, these complex metal oxide particles are preferably dispersed according to a known dispersing method, separately to a dispersion liquid (paste), before being added to a coating liquid for the particle containing layer. The metal oxides having a primary average particle diameter of less than 0.001 are not preferred since they are difficult to disperse. A dispersant is optionally used for dispersion. The addition amount of the dispersant is preferably from 0.01 to 5% by weight, and more preferably from 0.1 to 2% by weight, based on the weight of the complex metal oxide particles.

The content of the complex metal oxide in the hydrophilic layer is preferably from 20% by weight to less than 40% by weight, more preferably from 25% by weight to less than 39% by weight, and still more preferably from 25% by weight to less than 30% by weight, based on the total solid amount of hydrophilic layer. The content less than 20% by weight of the oxide provides poor sensitivity, while the content not less than 40% by weight of the oxide produces ablation scum due to ablation.

The hydrophilic layer or image formation layer in the invention can contain the following infrared absorbing dye as a light-to-heat conversion material.

Examples of the infrared absorbing dye include a general infrared absorbing dye such as a cyanine dye, a chloconium dye, a polymethine dye, an azulenium dye, a squalenium dye, a thiopyrylium dye, a naphthoquinone dye or an anthraquinone dye, and an organometallic complex such as a phthalocyanine compound, a naphthalocyanine compound, an azo compound, a thioamide compound, a dithiol compound or an indoaniline compound. Exemplarily, the light-to-heat conversion materials include compounds disclosed in Japanese Patent O.P.I. Publication Nos. 63-139191, 64-33547, 1-160683, 1-280750, 1-293342, 2-2074, 3-26593, 3-30991, 3-34891, 3-36093, 3-36094, 3-36095, 3-42281, 3-97589 and 3-103476. These compounds may be used singly or in combination.

The content of the infrared absorbing dye in the image formation layer is preferably from 0.1% by weight to less than 10% by weight, more preferably from 0.3% by weight to less than 7% by weight, and still more preferably from 0.5% by weight to less than 6% by weight, based on the total solid amount of hydrophilic layer. As is described above, the content less than 0.1% by weight of the oxide provides poor sensitivity, while the content not less than 10% by weight of the oxide produces ablation scum due to ablation.

(Back Coat Layer)

In the printing plate material of the invention, it is preferred that at least one structural layer is provided on the surface of the support opposite the image formation layer, in order to improve handling properties and minimize change in physical properties during storage. A preferred structural layer is a subbing layer, a hydrophilic binder-containing layer, or a hydrophobic binder-containing layer. The binder-containing layer may be provided on the subbing layer.

The subbing layer is preferably a subbing layer of the support described above.

The hydrophilic binder may be any as long as it exhibits hydrophilicity, and examples of the hydrophilic binder include resins having, as a hydrophilic group, a hydroxyl group such as polyvinyl alcohol (PVA), cellulose resins (methylcellulose MC, ethylcellulose EC, hydroxyethylcellulose HEC, carboxymethylcellulose CMC), chitins, or starch; resins having an ether bond such as polyethylene oxide PEO, polypropylene oxide PPO, polyethylene glycol PEG, or polyvinyl ether PVE; resins having an amide group or an amide bond such as polyacryl amide PAAM or polyvinyl pyrrolidone PVP; resins having as a dissociation group a carboxyl group such as polyacrylic acid salts, maleic acid resins, alginates or gelatins; polystyrene sulfonic acid salt; resins having an amino group, an imino group, a tertiary amino group or a quaternary ammonium group such as polyallylamine PAA, polyethylene imine PEI, epoxidated polyamide EPAM, polyvinyl pyridine or gelatins.

The hydrophobic binder may be any as long as it exhibits hydrophobicity, and examples of the hydrophobic binder include polymers derived from α,β-ethylenically unsaturated monomers such as polyvinyl chloride, chlorinated polyvinyl chloride, a copolymer of vinyl chloride and vinylidene chloride, a copolymer of vinyl chloride, and vinyl acetate, polyvinyl acetate, partially saponified polyvinyl acetate, polyvinyl acetal or preferably polyvinyl butyral in which a part of polyvinyl alcohol is acetalized with aldehyde, a copolymer of acrylonitrile and acryl amide, polyacrylates, polymethacrylates, polystyrene, polyethylene and a mixture thereof.

The hydrophobic binder may be water dispersible resins disclosed in Japanese Patent O.P.I. Publication No. 2002-258469, sections [0033] through [0038], as long as it can make the surface of the printing plate material hydrophobic.

It is preferred that the back coat layer contains a matting agent, in order to easily mount the printing plate on a printing press and to prevent “out of color registration” due to “out of registration” of the printing plate during printing. As the matting agent, a porous or non-porous matting agent or an organic or inorganic matting agent can be used. Examples of the inorganic matting agent include silica, alumina, zirconia, titania, carbon black, graphite, TiO₂, BaSO₄, ZnS, MgCO₃, CaCO₃, ZnO, CaO, WS₂, MOS₂, MgO, SnO₂, Al₂O₃, α-Fe₂O₃, α-FeOOH, SiC, CeO₂, BN, SiN, MoC, BC, WC, titanium carbide, corundum, artificial diamond, garnet, garnet, quartz, silica rock, tripoli, diatomite, and dolomite. Examples of the organic matting agent include polyethylene fine particles, fluororesin particles, guanamine resin particles, acrylic resin particles, silicone resin particles, melamine resin particles, and the like. As the inorganic material coated fillers, there are, for example, particles in which organic particles such as particles of PMMA or polystyrene as core particles are coated with inorganic particles with a particle diameter smaller that that of the core particles. The particle diameter of the inorganic particles is preferably from 1/10 to 1/100 of that of the core particles. As the inorganic particles, particles of known metal oxides such silica, alumina, titania and zirconia can be used. Various coating methods can be used, but a dry process is preferred which core particles collide with particles for coating at high speed in air as in a hybridizer to push the particles for coating in the core particle surface and fix, whereby the core particles are coated with the particles for coating.

Particles, in which the organic core particles are plated with metal, can be used. As such particles, there is, for example, “Micropearl AU”, produced by SEKISUI KAGAKU KOGYO Co, Ltd., in which resin particles are plated with gold.

In the planographic printing plate material in the form of roll, the matting agent in the back coat layer is preferably organic resin particles in minimizing scratches on the image formation layer surface. The average particle diameter of the matting agent is determined in terms of an average diameter of circles having the same area as projected images of the particles photographed by means of an electron microscope. The average particle diameter of the matting agent is preferably from 1 to 12 μm, more preferably from 1.5 to 8 μm, and still more preferably from 2 to 7 μm. The above range of the average particle diameter is preferred in minimizing scratches on the image formation layer surface, or in providing good fixation of a planographic printing plate material to a plate cylinder. The matting agent content of the back coat layer is preferably from 0.2 to 30% by weight, and more preferably from 1 to 10% by weight.

A laser recording apparatus or a processless printing press has a sensor for controlling transportation of the printing plate material. In the invention, in order to carry out the controlling smoothly, the structural layer preferably contains dyes or pigment. The dyes or pigment are preferably infrared absorbing dyes or pigment as described above used as a light-to-heat conversion material. The structural layer can further contain a surfactant.

### EXAMPLES

The present invention will be detailed employing the following examples, but the invention is not limited thereto.

### Example 1

<Preparation of Support>

Employing terephthalic acid and ethylene glycol, PET having an intrinsic viscosity VI of 0.66 (at 25° C. in a phenol/tetrachloroethane (6/4 by weight) solvent) was prepared according to a conventional method. The resulting polyethylene terephthalate was formed into pellets, dried at 130° C. for 4 hours, and melted at 300° C. The melted polyethylene terephthalate was extruded from a T-shaped die onto a 50° C. drum, and rapidly cooled. Thus, an unstretched film sheet having an average thickness of 175 μm was obtained. The film sheet was stretched in the mechanical direction at 102° C. by a stretching magnification of 1.3, and then at 110° C. by a stretching magnification of 2.6. Successively, the stretched film sheet was further stretched at 120° C. by a stretching magnification of 4.5 in the transverse direction in a tenter. The resulting sheet was heat fixed at 240° C. for 20 seconds and relaxed at 240° C. in the transverse direction by 4%. Thereafter, the sheet at the chuck portions in the tenter was cut off, and the both edges of the sheet were subjected to knurling treatment. The knurled sheet was cooled to 40° C., and wound around an up-take spool at a tension of 47.1 N/m. Thus, a biaxially stretched PET film sheet with a thickness of 175 μm was prepared. This PET film sheet had a glass transition temperature (Tg) of 79° C. The width of the PET film sheet had a width of 2.5 m. The thickness distribution of the sheet was 3%.

<Preparation of Subbed Support>

The both surfaces of the support prepared above were subjected to corona discharge treatment at 8 W/m²·minute. Subsequently, the following subbing layer coating solution “a” was coated on one side of the support to obtain a subbing layer with a wet thickness of 17 μm, and each of the subbing layer coating solutions “b-1” through “b-9” as shown in Table 1 below was coated on the resulting layer to obtain a subbing layer with a wet thickness as shown in Table 1, while carrying out corona discharge treatment (at 8 W/m²·minute), and dried at 180° C. for 4 minutes (The surface of the thus obtained subbing layer was designated as subbing layer surface A.) The following subbing layer coating solution “c” was coated on the rear surface of the support opposite the subbing layer surface A to obtain a subbing layer with a wet thickness of 8 μm, and the following subbing layer coating solution “d” was coated on the resulting layer to obtain a subbing layer with a wet thickness of 5 μm, while carrying out corona discharge treatment (at 8 W/m²·minute), dried at 180° C. for 4 minutes, and further subjected to corona discharge treatment at 8 W/m²·minute. (The surface of the thus obtained subbing layer was designated as subbing layer surface B.) Thus, subbed support samples 001 through 009 were prepared.

(Subbing Layer Coating Solution A)

| | |
|---|---|
| Latex of a copolymer of | 6.91 g |
| styrene/glycidyl methacrylate/butyl acrylate/aceto- | |
| acetoxyethyl methacrylate (39.5/40/20/0.5, | |
| solid content: 30%, Tg = 75° C.), | |
| Aqueous ethylene homopolymer dispersion | 0.42 g |
| (solid content: 10%) | |
| Anionic surfactant S-1 | 0.01 g |
| Pure water | 92.66 g |

Preparation of Hydrophilic Copolyester

Hydrophilic copolyester was prepared by polycondensation of a diol and a mixture of terephthalic acid, isophthalic acid, cyclohexane-1,4-dicarboxylic acid and sodiumsulfoisophthalic acid (40:38:14:8 by weight) below. 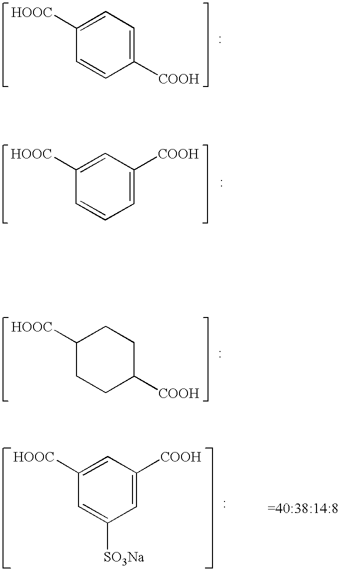
Preparation of Acryl-Modified Hydrophilic Polyester 1

Thirty six parts by weight of an acryl component, a mixture of methyl methacrylate, ethyl acrylate, glycidyl methacrylate (53:37:10 by weight), were polymerized in the presence of 64 parts by weight of hydrophilic copolyester obtained above to obtain acryl-modified hydrophilic polyester 1.

Preparation of Acryl-Modified Hydrophilic Polyester 2

Twenty parts by weight of an acryl component, a mixture of methyl methacrylate, glycidyl methacrylate (53:37:10 by weight), were polymerized in the presence of 80 parts by weight of hydrophilic polyester obtained above to obtain acryl-modified hydrophilic polyester 2.

TABLE 1
Subbing layer coating solutions b-1 through b-9

| Materials | b-1 | | b-2 | | b-3 | | b-4 | | b-5 | | b-6 | | b-7 | | b-8 | | b-9 | |
|---|---|---|---|---|---|---|---|---|---|---|---|---|---|---|---|---|---|---|
| Aqueous 5% polyvinyl | 0.00 | g | 0.09 | g | 0.37 | g | 9.15 | g | 18.31 | g | 18.31 | g | 18.31 | g | 45.78 | g | 58.59 | g |
| alcohol (with an average | | | | | | | | | | | | | | | | | | |
| molecular weight of | | | | | | | | | | | | | | | | | | |
| 1700) solution | | | | | | | | | | | | | | | | | | |
| Emulsion of acryl- | 6.33 | g | 6.31 | g | 6.24 | g | 4.22 | g | 2.11 | g | 0.00 | g | 2.11 | g | 5.28 | g | 6.75 | g |
| modified hydrophilic | | | | | | | | | | | | | | | | | | |
| polyester 1 (with a | | | | | | | | | | | | | | | | | | |
| solid content of 21.7%) | | | | | | | | | | | | | | | | | | |
| Anionic surfactant S-1 | 0.011 | g | 0.011 | g | 0.011 | g | 0.011 | g | 0.011 | g | 0.011 | g | 0.011 | g | 0.011 | g | 0.011 | g |
| Matting agent (silica | 0.004 | g | 0.004 | g | 0.004 | g | 0.004 | g | 0.004 | g | 0.004 | g | 0.004 | g | 0.004 | g | 0.004 | g |
| particles with an | | | | | | | | | | | | | | | | | | |
| average particle size | | | | | | | | | | | | | | | | | | |
| of 0.5 μm) | | | | | | | | | | | | | | | | | | |
| Pure water | 93.66 | g | 93.59 | g | 93.38 | g | 86.62 | g | 79.57 | g | 81.68 | g | 79.57 | g | 48.93 | g | 34.65 | g |
| Wet thickness | 11 | μm | 11 | μm | 11 | μm | 11 | μm | 11 | μm | 11 | μm | 110 | μm | 110 | μm | 110 | μm |

(Subbing Layer Coating Solution C)

| (Subbing layer coating solution c) | | |
|---|---|---|
| Tin oxide sol (solid content: 8.3%) | 10.95 | g |
| Latex of a copolymer of | 1.51 | g |
| n-butyl acrylate/styrene/glycidyl methacrylate (40/20/20, | | |
| solid content: 30%) | | |
| Latex of a copolymer of | 0.38 | g |
| n-butyl acrylate/t-butyl acrylate/styrene/hydroxymethyl | | |
| methacrylate (10/35/27/28, solid content: 30%) | | |
| Anionic surfactant S-1 | 0.05 | g |
| Pure water | 87.11 | g |
| (Subbing layer coating solution d) | | |
| Emulsion of acryl-modified hydrophilic | 14.34 | g |
| polyester 2 (with a solid content of 17.8%) | | |
| Anionic surfactant S-1 | 0.11 | g |
| Matting agent (silica particles with an average | 0.20 | g |
| particle size of 0.5 μm) | | |
| Pure water | 85.35 | g |

Anionic Surfactant S-1 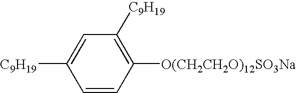
<Coating of Backing Layer Coating>

Materials in the following backing layer coating solution composition were sufficiently mixed while stirring, employing a homogenizer, and filtered to obtain a backing layer coating solution. The backing layer coating solution was coated, through a wire bar #6, on the subbing layer surface B of each of the subbed supports 001 through 009, which had been subjected to an 8 W/m²·minute corona discharge treatment, and allowed to pass through a 100° C. drying zone with a length 15 m at a transportation speed of 15 m/minute to form a backing layer with a coating amount of 2.0 g/m².

(Backing Layer Coating Solution Composition)

| | |
|---|---|
| Colloidal silica: Snowtex XS | 33.60 g |
| (solid content 20% by weight, produced by Nissan Kagaku | |
| Co., Ltd.) | |
| Acryl emulsion: DK-05 | 14.00 g |
| (solid content: 20% by weight, produced by GifuCerac Co., | |
| Ltd.) | |
| Matting agent (PMMA with an average particle size of 5.5 μm) | 0.56 g |
| Pure water | 51.84 g |

The backing layer coating solution composition had a solid content of 14% by weight.

<Coating of Lower Hydrophilic Layer and Upper Hydrophilic Layer>

Materials in the following upper and lower hydrophilic layer coating solution compositions were sufficiently mixed while stirring, employing a homogenizer, and filtered to obtain upper and lower hydrophilic layer coating solutions.

The lower hydrophilic layer coating solution was coated, through a wire bar #5, on the subbing layer surface A side of each of the resulting supports obtained above, and allowed to pass through a 100° C. drying zone with a length 15 m at a transportation speed of 15 m/minute to form a lower hydrophilic layer with a coating amount of 3.0 g/m². Successively, the upper hydrophilic layer coating solution was coated on the resulting lower hydrophilic layer employing a wire bar #3, and allowed to pass through a 100° C. drying zone with a length 30 m at a transportation speed of 15 m/minute to form an upper hydrophilic layer with a coating amount of 0.55 g/m². The resulting support samples were subjected to aging treatment at 60° C. for one day.

(Lower Hydrophilic Layer Coating Solution Composition)

| | | |
|---|---|---|
| Colloidal silica: Snowtex XS | 51.94 | g |
| (solid content 20% by weight, Described above) | | |
| Porous metal oxide particles Silton JC 40 | 2.22 | g |
| (porous aluminosilicate particles having an average | | |
| particle size of 4 μm, produced by Mizusawa Kagaku | | |
| Co., Ltd.) | | |
| Surface-coated melamine resin particles: | 3.00 | g |
| STM-6500S (produced by Nissan Kagaku Co., Ltd.) with an | | |
| average particle size of 6.5 μm | | |
| Gel of layer structural clay mineral | 4.44 | g |
| Particles, prepared by vigorously stirring Montmorillonite | | |
| Mineral Colloid MO (produced by Southern Clay Products | | |
| Co., Ltd.) with an average particle size of 0.1 μm) in | | |
| water in a homogenizer to give a solid content of 5% by | | |
| weight | | |
| Cu—Fe—Mn type metal oxide black | 10.00 | g |
| Pigment, TM-3550 black aqueous dispersion {prepared by | | |
| dispersing TM-3550 black powder having a particle size of | | |
| 0.1 μm produced by Dainichi Seika Kogyo Co., Ltd. in | | |
| water to give a solid content of 40% by weight (including | | |
| 0.2% by weight of dispersant)} | | |
| Aqueous 4% by weight sodium carboxymethyl | 2.80 | g |
| cellulose solution (Reagent produced by Kanto Kagaku Co., | | |
| Ltd.) | | |
| Aqueous 10% by weight sodium | 0.56 | g |
| phosphate · dodecahydrate solution (Reagent produced | | |
| by Kanto Kagaku Co., Ltd.) | | |
| Pure water | 25.04 | g |

The lower hydrophilic layer coating solution composition had a solid content of 12% by weight.

(Upper Hydrophilic Layer Coating Solution Composition)

| | | |
|---|---|---|
| Colloidal silica: Snowtex XS | 5.2 | g |
| (solid content 30% by weight, , produced by Nissan | | |
| Kagaku Co., Ltd.) | | |
| Necklace shaped colloidal silica | 11.7 | g |
| Snowtex PSM (solid 20% by weight, produced by Nissan | | |
| Kagaku Co., Ltd.) | | |
| Colloidal silica: MP-4540 | 4.5 | g |
| (having an average particle size of 0.4 μm, solid | | |
| content 30% by weight, produced by Nissan Kagaku | | |
| Co., Ltd.) | | |
| Porous metal oxide particles Silton JC 20 | 1.2 | g |
| (porous aluminosilicate particles having an average | | |
| particle size of 2 μm, produced by Mizusawa Kagaku | | |
| Co., Ltd.) | | |
| Porous metal oxide particles Silton AMT 08 | 3.6 | g |
| (porous aluminosilicate particles having an average | | |
| particle size of 0.6 μm, produced by Mizusawa Kagaku | | |
| Co., Ltd.) | | |
| Gel of layer structural clay mineral | 4.8 | g |
| Particles, prepared by vigorously stirring | | |
| Montmorillonite Mineral Colloid MO (described above) | | |
| with an average particle size of 0.1 μm) in water | | |
| in a homogenizer to give a solid content of 5% by weight | | |
| Cu—Fe—Mn type metal oxide black | 2.7 | g |
| Pigment, TM-3550 black aqueous dispersion {prepared | | |
| by dispersing TM-3550 black powder having a particle | | |
| size of 0.1 μm (Described above) in water to give a | | |
| solid content of 40% by weight (including 0.2% by weight | | |
| of dispersant)} | | |
| Aqueous 4% by weight sodium carboxymethyl | 3.00 | g |
| cellulose solution (Described above) | | |
| Aqueous 10% by weight sodium | 0.6 | g |
| phosphate · dodecahydrate solution (described above) | | |
| Pure water | 62.7 | g |

The upper hydrophilic layer coating solution composition had a solid content of 12% by weight.

<Coating of Image Formation Layer>

The image formation layer coating solution was coated, through a wire bar #5, on the upper hydrophilic layer obtained above, and allowed to pass through a 70° C. drying zone with a length 30 m at a transportation speed of 15 m/minute to form an image formation layer with a coating amount of 0.5 g/m². The resulting samples were subjected to aging treatment at 50° C. for two days to obtain a printing plate material. The printing plate material was cut into a 600 mm width, and wound around a paper core with an outside diameter of 76 mm. Thus, printing plate material roll samples 011 through 019 were obtained.

(Composition of Image Formation Layer Coating Solution)

| | | |
|---|---|---|
| Carnauba wax emulsion A118 | 16.88 | g |
| (with an average particle diameter of 0.3 μm, a | | |
| softening point of 65° C., a melting point of | | |
| 80° C., a melt viscosity at 140° C. of 8 cps and | | |
| a solid content of 40% by weight, produced by Gifu | | |
| Shellac Co., Ltd.) | | |
| Microcrystalline wax emulsion A206 | 6.25 | g |
| (with an average particle diameter of 0.5 μm, and a | | |
| solid content of 40% by weight, produced by Gifu Shellac | | |
| Co., Ltd.) | | |
| Sodium polyacrylate DL-522 | 2.50 | g |
| (with an average molecular weight of 170,000 and a solid | | |
| content of 30% by weight, produced by Nippon Shokubai | | |
| Co., Ltd.) | | |
| Surfinol 465 (produced by Nisshin Kagaku Co., Ltd.) | 1.00 | g |
| Isopropyl alcohol | 1.50 | g |
| Pure water | 74.38 | g |

The image formation layer coating solution composition had a solid content of 10.00% by weight.

Exposure (Image Formation)

Each of the printing plate material roll samples obtained above was wound around the exposure drum of an exposure device, fixed thereon, and exposed. Employing 830 laser beams with a wavelength of 830 nm and a spot diameter of 18 μm, exposure was carried out at exposure energy of 240 mJ/cm² to form an image at 2400 dpi (dpi means a dot number per 1 inch or 2.54 cm) and at a screen line number of 175. Thus, a planographic printing plate was obtained.

(Printing)

Employing the planographic printing plate obtained above, printing was carried out according to the following conditions, and evaluation was made.
Printing press: DAIYA 1F-1 produced by Mitsubishi Jukogyo Co., Ltd.
Printing paper sheet: coated paper sheet
Dampening water: a 2% by weight solution of Astromark 3 (produced by Nikken Kagaku Kenkyusyo Co., Ltd.)
Printing ink: The following two kinds of printing inks were employed, and evaluation was made regarding them.
Ink 1: Toyo King Hyeco M Magenta, produced by Toyo Ink Manufacturing Co.).
Ink 2: TM Hyeco SOY1, produced by Toyo Ink Manufacturing Co.)
   (Evaluation of Initial Printability, Paper Waste)

The number of paper sheets printed from when printing started till when an image with a good S/N ratio (where no stain was observed at non-image portions, i.e., the image formation layer at the non-image portions was completely removed on a press, and the image portions had a sufficient density, and particularly development failure, resulting from scratches of the image formation layer caused by the matting agent of the backing layer, was not observed.) was obtained was counted as the number of paper wastes, and evaluated as a measure of initial printability. The less the number of paper wastes is, the better the initial printability. The number of paper wastes of not less than 40 is practically problematic.

(Evaluation of Printing Durability)

The number of paper sheets printed from when printing started till when elimination of dots at the 3% dot image portion or density reduction at solid image potions was observed was counted and evaluated as printing durability.

The results are shown in Table 2.

TABLE 2

| Printing | | Coating | | | | | |
|---|---|---|---|---|---|---|---|
| plate | | amount of | Ink 1 | | Ink 2 | | |
| material | Subbed | polyvinyl | Initial | Printing | Initial | Printing | |
| roll | support | alcohol | printability | durability | printability | durability | |
| sample No. | sample No. | (g/m²) | (number) | (number) | (number) | (number) | Remarks |
| 011 | 001 | 0 | 10 | 500 | 12 | 500 | Comp. |
| 012 | 002 | 0.0005 | 10 | 2000 | 12 | 2000 | Comp. |
| 013 | 003 | 0.002 | 10 | 20000 | 12 | 20000 | Inv. |
| 014 | 004 | 0.05 | 10 | 22000 | 12 | 20000 | Inv. |
| 015 | 005 | 0.1 | 10 | 22000 | 12 | 21000 | Inv. |
| 016 | 006 | 0.1 | 10 | 23000 | 12 | 20000 | Inv. |
| 017 | 007 | 1 | 10 | 20000 | 12 | 21000 | Inv. |
| 018 | 008 | 2.5 | 10 | 20000 | 12 | 21000 | Inv. |
| 019 | 009 | 3.5 | 10 | 1500 | 12 | 1500 | Comp. |

Inv.: Inventive,
Comp.: Comparative

As is apparent from Table 2, the present invention improves excellent printing durability without lowering initial printability.

What is claimed is:

1. A planographic printing plate material comprising a plastic support and provided thereon, a subbing layer containing a water-soluble resin, a hydrophilic layer containing metal oxide particles with an average particle diameter of from 3 to 100 nm, and an image formation layer containing heat melting particles or heat fusible particles in that order, the planographic printing plate material being in the form of roll, wherein a dry coating amount of the water-soluble resin in the subbing layer is in the range of from 0.001 gm² to 3.0 g/m².

2. The planographic printing plate material of claim 1, wherein the water-soluble resin is selected from the group consisting of gelatin, carboxymethylcellulose, polyvinyl pyrrolidone, polyacrylic acid or its salts, and polyvinyl alcohol.

3. The planographic printing plate material of claim 2, wherein the water-soluble resin is gelatin or polyvinyl alcohol.

4. The planographic printing plate material of claim 3, wherein the water-soluble resin is polyvinyl alcohol.

5. The planographic printing plate material of claim 1, wherein the subbing layer further contains an acryl resin or an acryl-modified hydrophilic polyester.

6. The planographic printing plate material of claim 1, wherein the subbing layer consists of a first subbing layer and a second subbing layer provided on the first subbing layer, the water-soluble resin being contained in the second subbing layer.

7. The planographic printing plate material of claim 1, wherein the metal oxide particles are colloidal silica with an average particle diameter of from 3 to 20 nm.

8. The planographic printing plate material of claim 1, wherein the metal oxide particle content of the hydrophilic layer is from 1 to 10% by weight.

9. The planographic printing plate material of claim 1, wherein the hydrophilic layer consists of a first hydrophilic layer and a second hydrophilic layer.

10. The planographic printing plate material of claim 1, wherein at least one of the hydrophilic layer and the image formation layer further contains a light-to-heat conversion material.

11. The planographic printing plate material of claim 1, wherein the image formation layer further contains a light-to-heat conversion material in an amount of 1 to 90% by weight.

12. The planographic printing plate material of claim 1, wherein a back coat layer is provided on a rear surface of the support opposite the image formation layer.

13. The planographic printing plate material of claim 12, wherein the back coat layer contains a matting agent having an average particle diameter of from 1 to 12 μm in an amount of from 1 to 10% by weight.

14. The planographic printing plate material of claim 13, wherein the matting agent is an organic resin particle.

15. The planographic printing plate material of claim 1, wherein the plastic support is a sheet of polyethylene terephthalate or polyethylene naphthalate.

16. The planographic printing plate material of claim 1, wherein the plastic support has a thickness of from 50 to 500 μm, and a thickness dispersion of not more than 10%.

17. The planographic printing plate material of claim 1, wherein the plastic support has a thickness of from 120 to 400 μm, and a thickness dispersion of not more than 8%.

18. A planographic printing plate, which is obtained by a process comprising the step of forming an image on the planographic printing plate material of claim 1, employing a thermal head.

19. A printing process comprising the steps of:
imagewise exposing the printing plate material of claim 1 based on image information, employing a laser;
mounting the exposed printing plate material on a plate cylinder of a printing press without carrying out any wet development; and
carrying out printing to print an image on a printing paper sheet.
